(19) United States
(12) Patent Application Publication
(10) Pub. No.: US 2009/0205413 A1
(43) Pub. Date: Aug. 20, 2009

(54) DIAGNOSTIC APPARATUS FOR HIGH-PRESSURE FUEL SUPPLY SYSTEM

(75) Inventors: Shin YAMAUCHI, Mito (JP); Yoichi Iihoshi, Tsuchiura (JP); Toshio Hori, Hitachinaka (JP); Yoshikuni Kurashima, Mito (JP)

Correspondence Address: CROWELL & MORING LLP;INTELLECTUAL PROPERTY GROUP, P.O. BOX 14300, WASHINGTON, DC, 20044-4300, US

(73) Assignee: HITACHI, LTD., Tokyo (JP)

(21) Appl. No.: 12/353,537

(22) Filed: Jan. 14, 2009

(30) Foreign Application Priority Data
Feb. 15, 2008 (JP) 2008-034535

(51) Int. Cl. G01M 15/04

(52) U.S. Cl. 73/114.41; 73/114.38; 73/114.43; 73/114.45

(57) ABSTRACT

A diagnostic apparatus is combined with a high-pressure fuel supply system including a high-pressure fuel pump, a fuel rail, injectors, and a fuel pressure measuring unit for measuring fuel pressure in the fuel rail. The diagnostic apparatus is capable of detecting troubles in the high-pressure fuel pump and injectors and of discriminating between a trouble in the high-pressure fuel pump and a trouble in the injectors includes. The diagnostic apparatus includes: a pump discharge component calculating unit 111 for determining fuel pressure variation synchronous with the operation of the high-pressure fuel pump from the fuel pressure, an injection component calculating unit 112 for determining fuel pressure variation synchronous with the operation of the injectors, a rotating speed component calculating unit 113 for determining fuel pressure variation synchronous with the rotation of a drive shaft for driving the high-pressure fuel pump, a control component calculating unit 114 for determining fuel variation during a control operation for adjusting the fuel pressure to a predetermined desired fuel pressure, and a direct current component calculating unit 115 for calculating a direct current component of fuel pressure variation. The diagnostic apparatus decides whether or not the high-pressure fuel system is malfunctioning on the basis of results of calculation made by those calculating units.

### BACKGROUND OF THE INVENTION

1. Field of the Invention

The present invention relates to a diagnostic apparatus for a high-pressure fuel supply system for supplying high-pressure fuel to an internal combustion engine and, more particularly, to a diagnostic apparatus for diagnosing troubles in a high-pressure fuel supply system on the basis of fuel pressure variation in a fuel rail.

2. Description of the Related Art

Diagnostic techniques for diagnosing defects in parts and systems relating to the deterioration of the exhaust gas have been developed to prevent the deterioration of the quality of the exhaust gas discharged from internal combustion engines. A defect in a high-pressure fuel supply system, in particular, is directly related to an error in fuel injection quantity injected into the internal combustion engine in one injection cycle. Such a trouble causes the quality deterioration of the exhaust gas and affects the drivability and safety of the vehicle. Accordingly, many diagnostic techniques for diagnosing troubles in the high-pressure fuel supply system have been developed.

A diagnostic method of detecting a trouble in a high-pressure fuel supply system is disclosed in JP-T-2003-512566. This diagnostic method measures fuel pressure in a fuel rail, compares an actual frequency spectrum determined by frequency analysis with a normal frequency spectrum indicating a normal fuel pressure variation to diagnose the high-pressure fuel supply system on the basis of the result of comparison. This diagnostic method determines a frequency spectrum indicating driving cycles in which a high-pressure fuel pump is driven and a frequency spectrum indicating the rotation of the high-pressure fuel pump from the variation of fuel pressure in the fuel rail, and diagnoses the high-pressure fuel pump on the basis of the respective magnitudes of those frequency spectra.

A diagnostic method of diagnosing a high-pressure fuel supply system not using frequency analysis and using a filter is disclosed in JP-T-2003-532020. This diagnostic method determines the variation of fuel pressure in a fuel rail caused by the discharge operation of a high-pressure fuel pump and the variation of the frequency synchronous with the rotating speed of the drive shaft of the high-pressure fuel pump, determines the variation of fuel pressure during a normal operation, and diagnoses the high-pressure fuel system. This diagnostic method determines high-pressure fuel pump driving period and the variation of fuel pressure in the frequency band of the rotating speed of a driving shaft for driving the high-pressure fuel pump by using filtering instead of frequency spectra to diagnose the high-pressure fuel pump.

The conventional diagnostic apparatus concentrates attention only on a frequency component indicating a trouble in the high-pressure fuel pump and it is possible that the diagnostic apparatus makes a wrong diagnosis. For example, fuel discharge quantity that is discharged by the high-pressure fuel pump in one discharge cycle increases when fuel injection quantity that is injected by each of the injectors of an internal combustion engine in one injection cycle is increased and fuel pressure variation occurs every discharge cycle of the high-pressure fuel pump. Therefore, the conventional diagnostic method decides that the trouble is due to a trouble in the high-pressure fuel pump and is not due to a trouble in the injector.

### SUMMARY OF THE INVENTION

The present invention has been made to solve the foregoing problems and it is therefore an object of the present invention to provide a diagnostic apparatus capable of detecting troubles in a high-pressure fuel pump and injectors and of discriminating between a trouble in the high-pressure fuel pump and a trouble in the injectors.

The present invention provides a diagnostic apparatus, for a high-pressure fuel supply system including a high-pressure fuel pump capable of discharging high-pressure fuel, a fuel rail capable of accumulating the high-pressure fuel discharged by the high-pressure fuel pump, injectors connected to the fuel rail to inject the fuel into an internal combustion engine, and a fuel pressure measuring unit for measuring fuel pressure in the fuel rail; capable of controlling and diagnosing the high-pressure fuel pump on the basis of a fuel pressure measured by the fuel pressure measuring unit, includes: a pump discharge component calculating unit for determining fuel pressure variation synchronous with the operation of the high-pressure fuel pump from the fuel pressure; an injection component calculating unit for determining fuel pressure variation synchronous with the operation of the injectors; a rotating speed component calculating unit for determining fuel pressure variation synchronous with the rotation of a drive shaft for driving the high-pressure fuel pump; a control component calculating unit for determining fuel variation during a control operation for adjusting the fuel pressure to a predetermined desired fuel pressure; and a direct current component calculating unit for calculating a direct current component of fuel pressure variation; wherein a decision is made on whether or not the high-pressure fuel system is malfunctioning on the basis of results of calculation made by the pump discharge component calculating unit, the injection component calculating unit, the rotating speed component calculating unit, the control component calculating unit, and the direct current component calculating unit. Thus, discrimination between a trouble in the high-pressure fuel pump and a trouble in the injector can be made.

The diagnostic apparatus according to the present invention may further include a fuel pressure component comparing unit for comparing the pump discharge component, the injection component, the rotating speed component, the control component and the direct current component to determine order of magnitude of those components, and a trouble type determining unit for determining a trouble in the high-pressure fuel system on the basis of the result of comparison made by the fuel pressure component comparing unit. Thus diagnosis can be made taking influences of the devices including the high-pressure fuel pump and the injectors.

In the diagnostic apparatus according to the present invention, the trouble type determining unit stores beforehand normal patterns showing the relation in magnitude among the components when the high-pressure fuel system is in a normal operation, decides that the high-pressure fuel system is in a normal condition when a pattern based on the result of comparison made by the fuel pressure component comparing unit coincides with the normal patterns or the high-pressure fuel system is in an abnormal condition when the pattern does not coincide with the normal pattern. Only the normal pattern of the fuel pressure variation component in the normal condition is stored and a decision can be made that the high-pressure fuel system is in an abnormal condition when the measured pattern does not coincide with the normal pattern. Thus, accurate diagnosis can be made by a simple method.

In the diagnostic apparatus according to the present invention, the trouble type determining unit stores beforehand at least one of magnitude patterns of the components when the high-pressure fuel system is in an abnormal condition, and the type of a trouble in the high-pressure fuel system is determined when the measured pattern based on the result of comparison made by the fuel pressure component comparing unit coincides with the trouble pattern. Thus, the occurrence of a trouble can be detected and, at the same time, a malfunctioning part and causes of malfunction can be known by using abnormality patterns of all the presumable troubles.

The diagnostic apparatus according to the present invention decides that the high-pressure fuel system is in a normal condition when the pump discharge component is the largest, the injection component is the second largest, and the rotating speed component, the control component and the direct current component are smaller than the lower limit of a predetermined range. Thus, diagnosis can discriminate the abnormal total fuel discharge state of the high-pressure fuel pump from other troubles.

The diagnostic apparatus according to the present invention decides that the high-pressure fuel pump is malfunctioning and is not discharging the fuel when the direct current component is the largest and the injection component is the second largest. Thus diagnosis discriminating the abnormal fuel discharge state of the high-pressure fuel pump where the high-pressure fuel pump is not discharging the fuel from other troubles can be made.

The diagnostic apparatus according to the present invention decides that the high-pressure fuel pump is malfunctioning and not discharging the fuel when the injection component is the largest. Thus diagnosis discriminating the abnormal fuel discharge state of the high-pressure fuel pump where the high-pressure fuel pump is not discharging the fuel from other troubles can be made.

The diagnostic apparatus according to the present invention decides that the high-pressure fuel pump is in an abnormal total fuel discharge state when the direct current component is the largest and the pump discharge component is the second largest. Thus diagnosis discriminating the abnormal total fuel discharge state of the high-pressure fuel pump from other troubles can be made.

The diagnostic apparatus according to the present invention decides that the high-pressure fuel pump is in an abnormal total fuel discharge state when the pump discharge component is the largest. Thus diagnosis discriminating the abnormal total fuel discharge state of the high-pressure fuel pump from other troubles can be made.

The diagnostic apparatus according to the present invention decides that a pump driving cam for driving the high-pressure fuel pump has a trouble when the pump discharge component is the largest, the rotating speed component is the second largest and the injection component is the third largest among the components. Thus, diagnosis discriminating a trouble in the cam driving the high-pressure fuel pump from other troubles can be made.

The diagnostic apparatus according to the present invention decides that time for which a fuel suction valve connected to the suction port of the high-pressure fuel pump is open is irregular when the pump discharge component is the largest, the control component is the second largest and the injection component is the third largest among the components. Thus, diagnosis discriminating the variation of time for which the suction valve connected to the suction port of the high-pressure fuel pump is open from other troubles can be made.

The diagnostic apparatus according to the present invention decides that the injector is clogged or the solenoid is abnormal when the pump discharge component is the largest, the injection component is the second largest and the rotating speed component is the third largest. Thus, diagnosis discriminating a trouble in the injector can be from other troubles can be made.

The diagnostic apparatus according to the present invention decides that fuel injection quantity that is injected by the injector in one injection cycle is varying when the pump discharge component is the largest, the injection component is the second largest and the control component is the third largest among the components. Thus, diagnosis discriminating the variation of fuel injection quantity from other troubles can be made.

The diagnostic apparatus according to the present invention executes a process for prohibiting or interrupting a diagnostic operation for diagnosing the high-pressure fuel supply system when a fuel discharge quantity that is discharged in a predetermined period by the high-pressure fuel pump and a fuel injection quantity that is injected by the injectors in the same predetermined period do not coincide with each other, i.e., in a discharge-injection unbalanced state where fuel discharge quantity and fuel injection quantity are not equilibrated. Thus, it is possible to avoid wrong diagnosis in a discharge-injection unbalanced state.

The diagnostic apparatus according to the present invention executes a process for prohibiting or interrupting a diagnostic operation for diagnosing the high-pressure fuel supply system at the start of the internal combustion engine or when the fuel is cut. Thus, it is possible to avoid wrong diagnosis in a discharge-injection unbalanced state.

According to the present invention, it is possible to detect the abnormal condition of the high-pressure fuel supply system with discrimination between a trouble in the high-pressure fuel pump and a trouble in the injector.

### BRIEF DESCRIPTION OF THE DRAWINGS

The above and other objects, features and advantages of the present invention will become apparent from the following description taken in connection with the accompanying drawings, in which:

FIG. 1 is a schematic diagram of a high-pressure fuel supply system provided with a diagnostic apparatus in a preferred embodiment according to the present invention;

FIG. 2 is a block diagram of a diagnostic apparatus in a preferred embodiment according to the present invention;

FIG. 3 is a flow chart of a diagnostic procedure;

FIGS. 4A, 4B and 4C are a graph showing the relation between fuel discharge quantity and fuel injection quantity when the high-pressure fuel supply system is in a normal operation, a graph showing the waveform of fuel pressure when the high-pressure fuel supply system is in a normal operation, and a power spectrum obtained from the waveform of fuel pressure shown in FIG. 4B, respectively;

FIGS. 5A, 5B and 5C are a block diagram of assistance in explaining a control operation for controlling a high-pressure fuel supply system, an expression showing a linear transfer function, and a Bode's diagram, respectively;

FIGS. 6A and 6B are a graph showing the relation between fuel discharge quantity and fuel injection quantity when a high-pressure fuel pump is in failure in discharging the fuel, and a graph showing fuel pressure waveform when the high-pressure fuel pump is in failure in discharging the fuel, respectively;

FIGS. 7A and 7B are a graph showing a power spectrum in a discharge-injection unbalanced state where fuel discharge quantity and fuel injection quantity are not equilibrated, and a graph showing a power spectrum in a discharge-injection balanced state where fuel discharge quantity and fuel injection quantity are equilibrated, respectively, obtained from the fuel pressure waveform shown in FIG. 6B;

FIGS. 8A, 8B and 8C are a graph showing the relation between fuel discharge quantity and fuel injection quantity when the high-pressure fuel pump of the high-pressure fuel supply system is in an abnormal total discharge state, a graph showing discharge rate when the high-pressure fuel pump is in an abnormal total discharge state, and a graph showing a fuel pressure waveform when the high-pressure fuel pump is in an abnormal total discharge state, respectively;

FIGS. 9A and 9B are a graph showing a power spectrum in a discharge-injection unbalanced state, and a graph showing a power spectrum in a discharge-injection balanced state, respectively obtained from a fuel pressure waveform shown in FIG. 8C;

FIGS. 10A, 10B and 10C are a graph showing the relation between fuel discharge quantity and fuel injection quantity when the a pump driving cam for driving a high-pressure fuel pump is malfunctioning, a graph showing the waveform of fuel pressure when the pump driving cam is malfunctioning, and a power spectrum obtained from the waveform of fuel pressure shown in FIG. 10B, respectively;

FIGS. 11A, 11B and 11C are a graph showing the relation between fuel discharge quantity and fuel injection quantity when suction valve opening duration for which the suction valve of a high-pressure fuel pump is opened is irregular, a graph showing the waveform of fuel pressure when suction valve opening duration for which the suction valve of a high-pressure fuel pump is opened is irregular, and a graph showing a power spectrum obtained from the waveform of fuel pressure shown in FIG. 11B, respectively;

FIGS. 12A, 12B and 12C are a graph showing relation between fuel discharge quantity and fuel injection quantity when an injector is malfunctioning (clogged), a graph showing the waveform of fuel pressure when an injector is malfunctioning (clogged), and a graph showing a power spectrum obtained from the waveform of fuel pressure shown in FIG. 12B, respectively;

FIGS. 13A, 13B and 13C are a graph showing the relation between fuel discharge quantity and fuel injection quantity when an injector is malfunctioning (solenoid is defective), a graph showing the waveform of fuel pressure when an injector is malfunctioning (solenoid is defective), and a graph showing a power spectrum obtained from the waveform of fuel pressure shown in FIG. 13B, respectively;

FIGS. 14A and 14B are a graph showing a power spectrum when an injector is clogged, and a graph showing a power spectrum when the solenoid of an injector is defective, respectively, for explaining discrimination between a trouble resulting from the clogging an injector and a trouble resulting from the malfunction of the solenoid of an injector;

FIGS. 15A, 15B and 15C are graphs showing the relation between fuel discharge quantity and fuel injection quantity, the waveform of fuel pressure and a power spectrum obtained from the waveform of fuel pressure shown in FIG. 15B, respectively, when some of the injectors are malfunctioning (fuel injection quantities are irregular);

FIG. 16 is a table showing calculated patterns and their corresponding abnormal patterns;

FIG. 17 is a flow chart of a diagnosis prohibiting procedure;

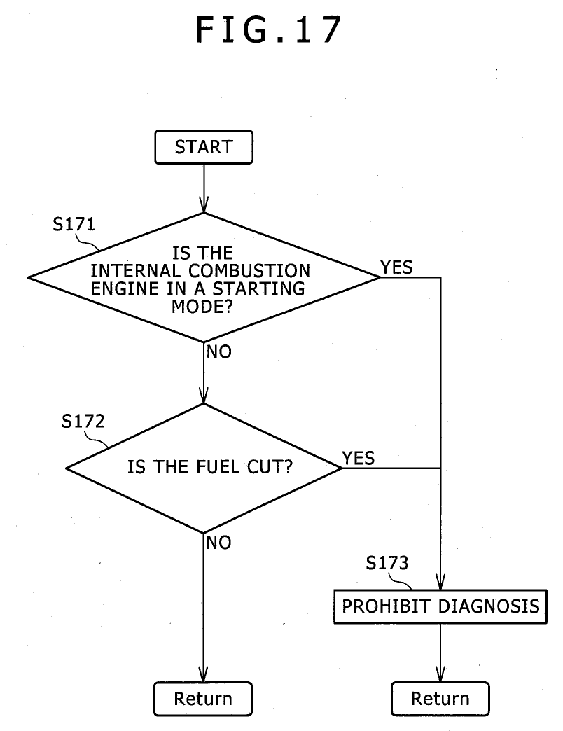

FIGS. 18A and 18B are a graph showing a waveform of fuel pressure, and a waveform of a pump discharge component extracted from the waveform of fuel pressure shown in FIG. 18A by filtering, respectively;

FIGS. 19A and 19B are a graph showing a waveform of fuel pressure, and a waveform of an injection component extracted from the waveform of fuel pressure shown in FIG. 19A by filtering, respectively;

FIGS. 20A and 20B are a graph showing a waveform of fuel pressure, and a waveform of a rotating speed component extracted from the waveform of fuel pressure shown in FIG. 20A by filtering, respectively; and

FIGS. 21A and 21B are a graph showing a waveform of fuel pressure, and a waveform of a control component extracted from the waveform of fuel pressure shown in FIG. 21A by filtering, respectively.

### DESCRIPTION OF THE PREFERRED EMBODIMENTS

Preferred embodiments of the present invention will be described with reference to the accompanying drawings.

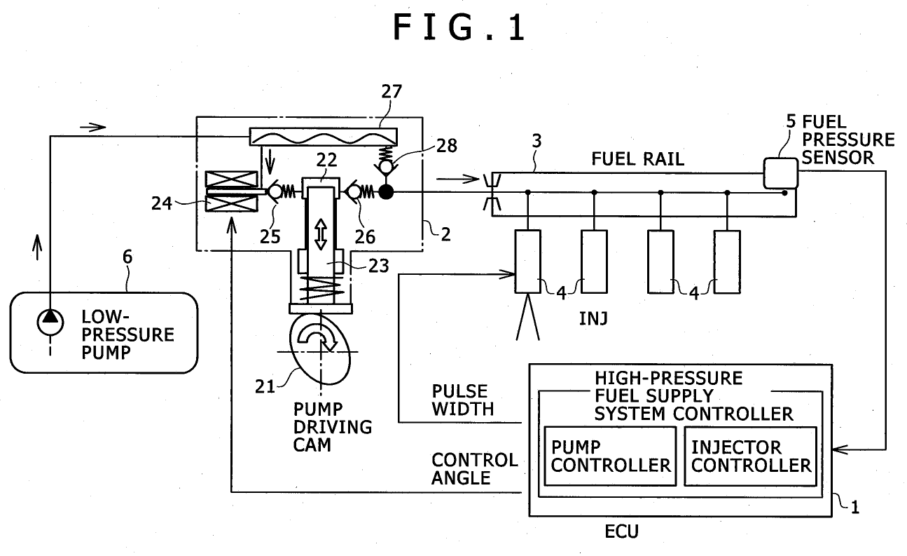

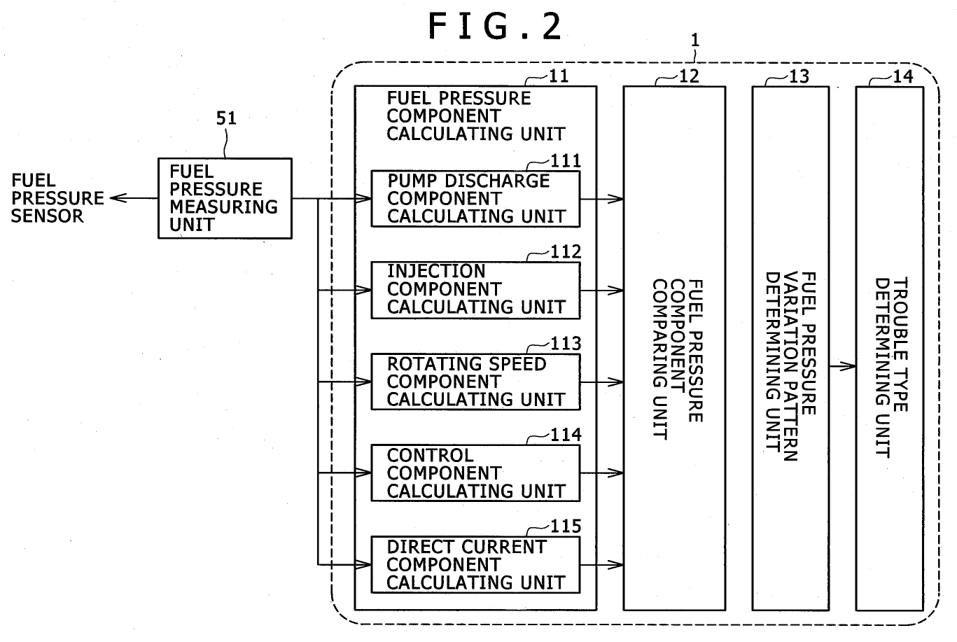

FIG. 1 is a block diagram of a high-pressure fuel supply system provided with a diagnostic apparatus in a preferred embodiment according to the present invention, and FIG. 2 is a block diagram of the diagnostic apparatus.

Referring to FIG. 1, the high-pressure fuel system includes a high-pressure fuel pump 2 that raises the pressure of the discharged fuel, a fuel rail 3 for accumulating the fuel discharged from the high-pressure fuel pump 2, injector 4 connected to the fuel rail 3 to inject the fuel into an internal combustion engine, a fuel pressure sensor 5 for measuring the pressure of the fuel accumulated in the fuel rail 3, and a diagnostic apparatus 1 that controls the high-pressure fuel pump 2 and fuel injection quantity to be injected by each injector 4 in each fuel injection cycle and diagnoses the high-pressure fuel pump 2 and the injectors 4.

A low-pressure pump 6 is disposed on the upstream side of the high-pressure fuel pump 2. The high-pressure fuel pump 2 receives the fuel supplied from a fuel tank, not shown, by the low-pressure pump 6, raises the pressure of the discharged fuel and supplies the high-pressure fuel to the fuel rail 3. The high-pressure fuel pump 2 has a cylinder, a piston 23 fitted in the cylinder. The piston 23 raises the pressure of the fuel supplied in a pressure chamber 22 by the low-pressure pump 6. A pump driving cam 21 rotates to drive the piston 23 for axial reciprocation in the cylinder to raise the pressure of the fuel supplied into the pressure chamber 22. In this embodiment, the high-pressure fuel pump 2 is a single-cylinder high-pressure fuel pump that executes three fuel discharge cycles while the pump driving cam 21 makes one full turn. A suction valve 25 operated by a solenoid 24 (solenoid valve) is connected to a part of the pressure chamber 22 on the fuel receiving side (on the side of the lo-pressure pump 6), and a discharge valve 26 is connected to a part of the pressure chamber 22 on the fuel discharge side (on the side of the fuel rail 3). A fuel line 27 connected to the low-pressure pump 6 is connected through a relief valve 28 to a line connecting the discharge valve 26 to the fuel rail 3.

The discharge valve 26 of the high-pressure fuel pump 2 is connected to the fuel rail 3. A fuel pressure sensor 5 for measuring fuel pressure in the fuel rail 3 is connected to the fuel rail 3. The fuel pressure in the fuel rail 3 is determined (calculated) on the basis of an output signal provided by the fuel pressure sensor 5. A signal conveying the fuel pressure thus determined is given to the diagnostic apparatus 1.

At least one injector 4 is connected to the fuel rail 3 to inject the fuel accumulated in the fuel rail 3 into the internal combustion engine 6. The internal combustion engine to which this high-pressure fuel supply system is connected is a six-cylinder internal combustion engine and hence size injectors 4 is connected to the fuel rail 3. In FIG. 1, only the four injectors 4 among the six injectors 4 are shown.

The diagnostic apparatus 1 electronically controls an operation for driving the solenoid 24 of the high-pressure fuel pump 2, namely, an operation for timing opening and closing the suction valve 26, an operation for driving the injectors 4, namely, an operation for controlling injection pulse width. The diagnostic apparatus 1 diagnoses the high-pressure fuel pump 2 and the injectors 4 to detect troubles. The diagnostic apparatus 1 is called also an electronic control unit (ECU). The diagnostic apparatus 1 is connected to a fuel pressure measuring unit 51 to receive a fuel pressure signal provided by the fuel pressure measuring unit 51. The diagnostic apparatus 1 is connected to the high-pressure fuel pump 2 and the injectors 4 to control operations for driving the solenoid 24 of the high-pressure fuel pump 2 and for driving the injectors 4.

Referring to FIG. 2, the diagnostic apparatus 1 is provided with a fuel pressure component calculating unit 11 for calculating components of fuel pressure variation in the fuel rail 3 by using measured data provided by the fuel pressure measuring unit 51, a fuel pressure component comparing unit 12 for comparing the magnitudes of calculated fuel pressure components, a fuel pressure variation pattern determining unit 13 for storing results of comparison of the fuel pressure components and determining a fuel pressure variation pattern, and a trouble type determining unit 14 for determining a trouble in the high-pressure fuel supply system on the basis of the fuel pressure variation pattern.

The fuel pressure component calculating unit 11 includes a pump discharge component calculating unit 111 for calculating a component of fuel pressure variation caused by the fuel discharge operation of the high-pressure fuel pump 1, an injection component calculating unit 112 for calculating a component of fuel pressure variation caused by fuel injection, a rotating speed component calculating unit 113 for calculating a component of fuel pressure variation synchronous with the rotating speed of the pump driving cam 21, a control component calculating unit 114 for calculating a component of fuel pressure variation caused by a feedback control operation for adjusting the fuel pressure to a value near a desired fuel pressure, and a direct current component calculating unit 115 for calculating a direct current component of fuel pressure variation. The foregoing units are the minimum components necessary for realizing the diagnostic apparatus 1 in this embodiment and the diagnostic apparatus 1 may include calculating units for calculating other components.

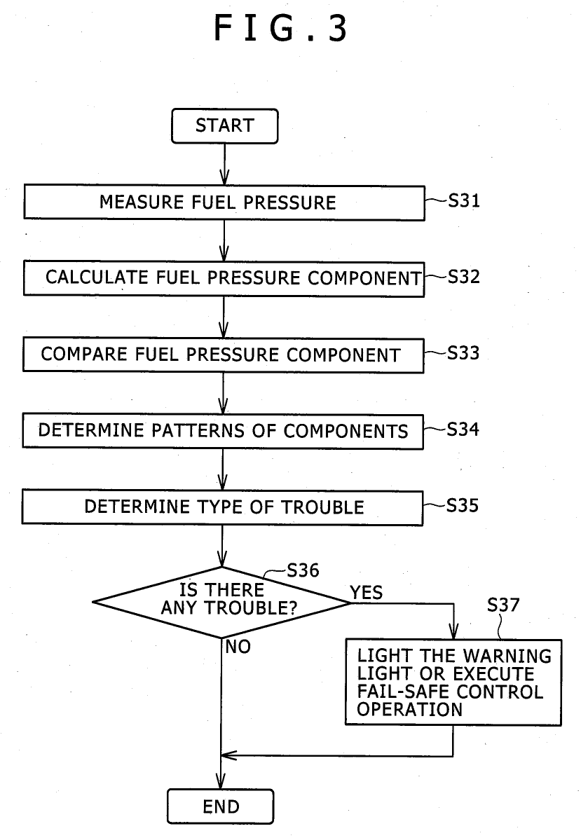

A diagnostic procedure to be carried out by the diagnostic apparatus 1 to diagnose the high-pressure fuel supply system will be described with reference to FIGS. 3 to 15.

Referring to FIG. 3 showing a flow chart of a diagnostic procedure to be carried out by the diagnostic apparatus 1, the fuel pressure measuring unit 51 provides, in step S31, a fuel pressure signal(fuel pressure waveform signal) conveying a measured fuel pressures measured by the fuel pressure sensor 5. In step S32, the fuel pressure component calculating unit 11 calculates a pump discharge component, an injection component, a rotating speed component, a control component and a direct current component on the basis of the fuel pressure signal provided by the fuel pressure measuring unit 51. Each of those components is a specific frequency component, namely, a peak, obtained by converting the fuel pressure waveform into a frequency characteristic (power spectrum) by Fourier transform or the like. Those components will be described later. The fuel pressure component comparing unit 12 compares the respective magnitudes of the components and gives the results of comparison to the fuel pressure variation pattern determining unit 13. The fuel pressure component comparing unit 12 stores a power spectrum when the high-pressure fuel supply system is in a normal state empirically obtained previously. The fuel pressure component comparing unit 12 compares the respective magnitudes of its components (absolute values) and the respective magnitudes (absolute values) of components provided by the fuel pressure component calculating unit 11 in step S33.

The fuel pressure variation pattern determining unit 13 stores the results of fuel pressure comparison made by the fuel pressure component comparing unit 12 (the relation in magnitude among the components and magnitudes of the components) and determines patterns of those components (calculated patterns) in step S34. After the patterns have been determined, the trouble type determining unit 14 determines whether or not the system is normal and identifies the types of troubles on the basis of the calculated patterns in step S35.

More concretely, it is decided that the high-pressure fuel supply system is in a normal state when the calculated patterns coincide with the stored patterns for a normal state, respectively.

If the calculated patterns are different from the patterns for a normal state, it is decided that the system is in an abnormal state. A plurality of kinds of trouble type patterns of the components for different types of troubles are stored beforehand in the trouble type determining unit 14. When the calculated pattern provided by the calculated pattern determining unit 13 coincides with one of the plurality of trouble type patterns, the type of a trouble in the system can be identified. Troubles that can be determined by the diagnostic apparatus 1 are a trouble making the high-pressure fuel pump 2 unable to discharge the fuel, a trouble causing the high-pressure fuel pump 2 to be in an abnormal total discharge state, a trouble in the pump driving cam 21, a trouble making the suction valve of the high-pressure fuel pump 2 operate irregularly, a trouble in the injector, and a trouble making the injector inject the fuel irregularly. The relation between the calculated pattern and the trouble type will be described later.

If the response to a query made in step S36 is negative, it is decided that the high-pressure fuel supply system is normal and the diagnostic procedure is ended. If the response to the query made in step S36 is affirmative and it is decided that the high-pressure fuel supply system is abnormal, a warning lamp is lighted or a fail-safe control operation is executed in step S37.

The relation between the components of the power spectrum (calculated patterns) and the types of troubles in the high-pressure fuel supply system will be described.

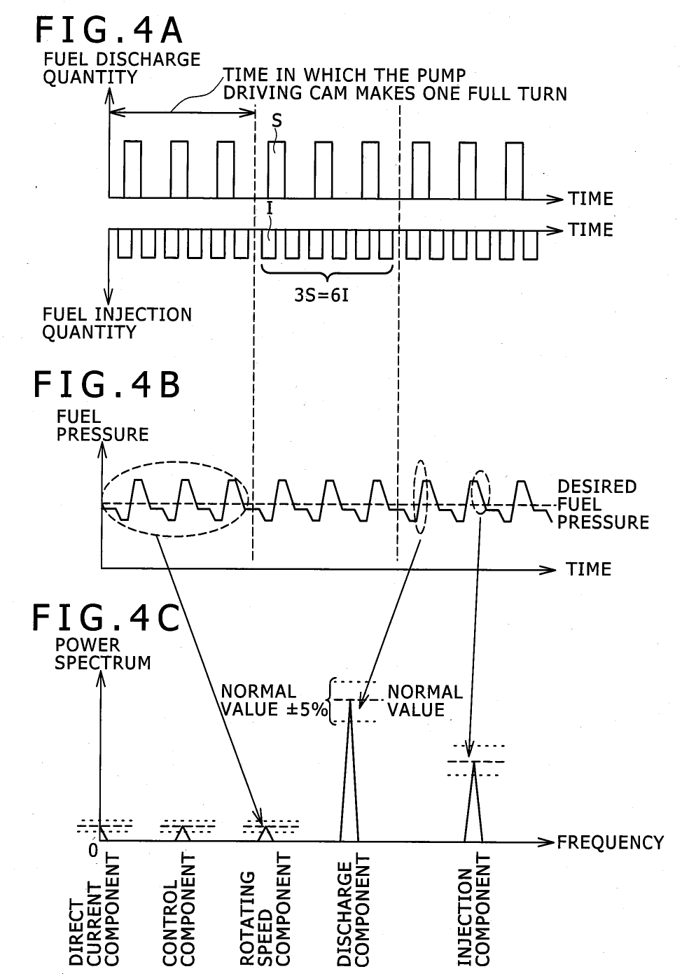

FIG. 4A is a graph showing the relation between a fuel discharge operation of the high-pressure fuel pump 2 and a fuel injection operation of the injectors 4 when the high-pressure fuel supply system is in a normal operation.

As shown in FIG. 4A, the high-pressure fuel pump 2 discharges the fuel three times into the fuel rail 3 and each of the six injectors 4 injects the fuel once while the pump driving cam 21 makes one full turn. When the high-pressure fuel supply system is operating normally, the amount 3S of the fuel supplied into the fuel rail 3 by the high-pressure fuel pump 2 while the pump driving cam 21 makes one full turn is equal to the amount 6I of the fuel injected by the six injectors 4. Thus fuel discharge quantity and fuel injection quantity are equilibrated.

FIG. 4B is a graph showing the variation of fuel pressure with time (fuel pressure waveform) when the high-pressure fuel supply system is operating normally. As obvious from FIG. 4B, the fuel pressure in the fuel rail 3 increases when the high-pressure fuel pump 2 discharges the fuel into the fuel rail 3 and decreases when the fuel is injected. Fuel discharge quantity and fuel injection quantity are equilibrated when the high-pressure fuel supply system is operating normally. Therefore, an increase and a decrease of the fuel pressure are equal and the fuel pressure in the fuel rail 3 remains substantially equal to a desired fuel pressure.

FIG. 4C is a power spectrum obtained through the frequency analysis of the fuel pressure waveform shown in FIG. 4B when the high-pressure fuel supply system is operating normally. As obvious from FIG. 4C, the power spectrum has an injection component, a pump discharge component, a rotation component, a control component and a direct current component in decreasing order of frequency.

The components of the power spectrum will be described.

The injection component indicates a decrease in the fuel pressure resulting from fuel injection and is synchronous with injector driving period. The pump discharge component indicates an increase in the fuel pressure resulting from fuel discharge by the high-pressure fuel pump 2 and is synchronous with pump driving period. The direct current component is a component having a frequency of 0 Hz and indicating the monotonous increase or decrease of fuel pressure. The rotating speed component is a component resulting from the variation of fuel pressure synchronous with the rotation period of the pump driving cam 21 for driving the high-pressure fuel pump 2. The control component is a component having a peak in a frequency band below the rotating speed component. The control component results from fuel pressure variation in the fuel rail 3.

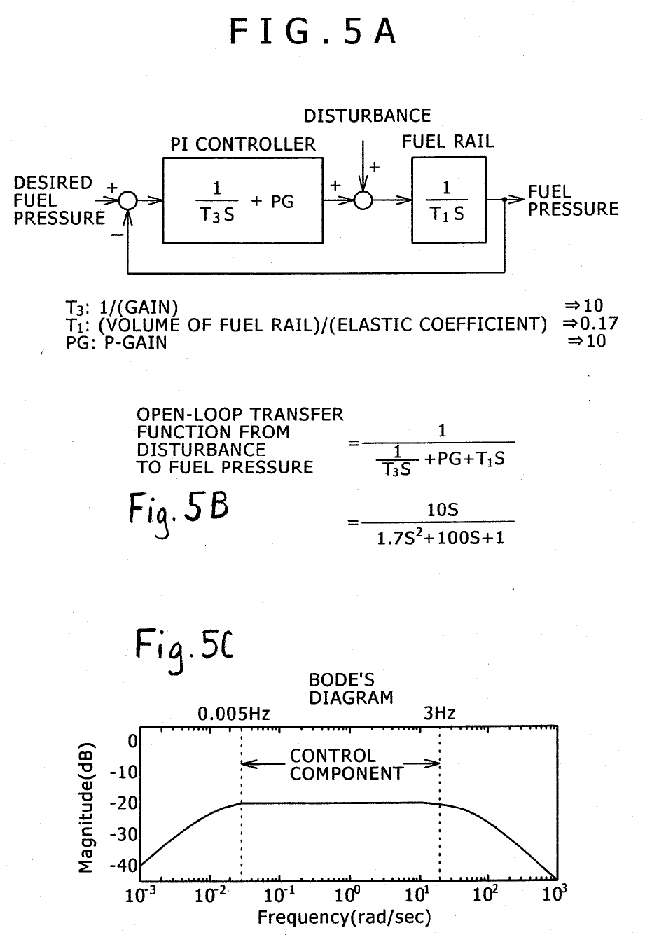

A method of determining a frequency corresponding to the control component will be described with reference to FIGS. 5A and 5B. As shown in FIG. 5A, a controller, namely, a proportional-plus-integral controller (PI controller) controls the fuel pressure in the fuel rail 3 such that the fuel pressure is approximately equal to a desired fuel pressure. The controller is simulated by a theoretical model expressed by Expression (1) showing fuel pressure by the integral of the product of the ratio of the elastic coefficient of the fuel to the volume of the fuel rail (1/T1) and the amount of the fuel contained in the fuel rail with respect to t.

$$Fuel pressure = \int \frac{elastic coefficient}{volume of fuel rail} ! amount of fuel ( d t ) \vert \qquad Expression ( 1 )$$

In this embodiment, the elastic coefficient of the fuel is 1000 MPa (experimental value) and the volume of the fuel rail 3 is 170 cm³ (experimental value).The amount of the fuel that can be accumulated in the fuel rail 3 is the sum of the product of fuel pressure deviation and the gain of the controller and disturbance. Therefore, an open-loop transfer function of the high-pressure fuel supply system with respect to disturbance is represented by an expression shown in FIG. 5B. FIG. 5C shows a Bode's diagram obtained by using the linear transfer function shown in FIG. 5B. As obvious from the Bode's diagram, a frequency range in which the gain characteristic of the disturbance is a maximum in between about 0.005 and about 3 Hz. It is known from the Bode's diagram that the influence of the disturbance of a frequency in the frequency band between 0.005 and 3 Hz on the high-pressure fuel supply system is more significant than those in frequency bands other than the frequency band between 0.005 and 3 Hz. Thus, a component of a frequency between 0.005 and 3 Hz among the variation of fuel pressure is a component of disturbance and is defined as a control component. A method of selecting the control component may select an optional region other than a region in which the gain characteristic is a maximum.

Referring again to FIG. 4C, the pump discharge component indicating the increase of the fuel pressure resulting from the supply of the fuel into the fuel rail 3 is the largest and the injection component indicating the drop in the fuel pressure resulting from injection is the second largest in the power spectrum when the high-pressure fuel supply system is normal. The direct current component, the control component and the rotating speed component are substantially zero when the high-pressure fuel supply system is normal. The value of each of those components in the range of the experimental value minus 5% to the experimental value plus 5% is considered to be normal taking into consideration irregular operations of the high-pressure fuel pump 2 and the injectors 4 and mechanical errors. The normal values may be values estimated from fuel discharge quantity that is discharged by the high-pressure fuel pump 2 in one discharge cycle and fuel injection quantity that is injected by each injector 4 in one injection cycle, the volume of the fuel rail 3 and the elastic coefficient of the fuel.

The diagnostic apparatus 1 decides that the high-pressure fuel supply system is operating normally when the pump discharge component is the largest, the injection component is the second largest, and the rotating speed component and the control component are substantially zero in the pattern of the calculated power spectrum. The diagnostic apparatus 1 decides that the high-pressure fuel supply system is operating abnormally when the pattern of the calculated power spectrum is different from the pattern indicating a normal state. The diagnostic apparatus 1 can specify the types of troubles from calculated patterns provided by the component calculating units 111 to 115 of the fuel pressure component calculating unit 11.

The relation between the type of each trouble and the calculated pattern will be described.

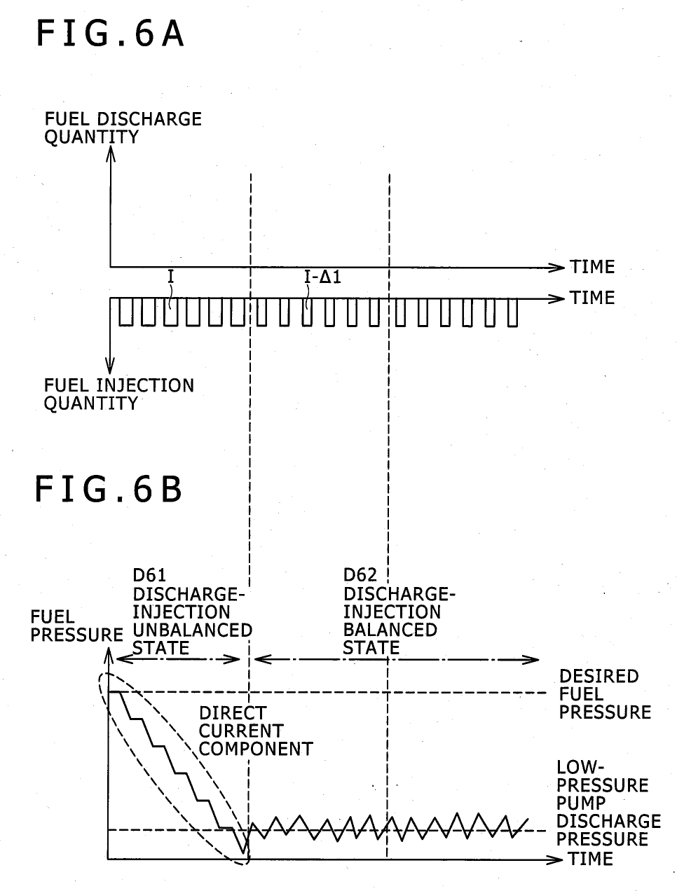

FIG. 6A is a graph showing the relation between fuel discharge quantity and fuel injection quantity when the high-pressure fuel pump 2 malfunctions and not discharging the fuel and FIG. 6B is a graph showing the waveform of fuel pressure when the high-pressure fuel pump 2 is not discharging the fuel.

It is known from FIG. 6A that the high-pressure fuel pump 2 is not discharging any fuel at all. Even if the high-pressure fuel pump 2 is not discharging the fuel, each of the injectors 4 injects the predetermined amount I of the fuel in each injection cycle in a time period D61 in which the fuel is contained in the fuel rail 3. As shown in FIG. 6B, the fuel pressure in the fuel rail 3 decreases every injection cycle while the fuel is contained in the fuel rail 3, and the fuel pressure drops to a value equal to a fuel pressure produced by the low-pressure fuel pump 6 that supplies the fuel to the high-pressure fuel pump 2.

When the fuel pressure in the fuel rail 3 decreases continuously to a value below the pressure produced by the low-pressure fuel pump 6, the fuel cannot be supplied into the fuel rail 3 and the internal combustion engine stops. To make the internal combustion engine continue its operation, the injectors 4 inject a fuel injection quantity equal to a fuel supply quantity I-ΔI supplied by the low-pressure pump 6 into the fuel rail 3, and the fuel pressure in the fuel rail 3 is maintained at temperatures around the fuel pressure at which the low-pressure pump 6 supplies the fuel. In a time period D62 in which the fuel pressure in the fuel rail 3 is maintained at temperatures around the fuel pressure at which the low-pressure pump 6 supplies the fuel, the amount of the fuel injected by the injectors 4 equilibrates with the amount of the fuel supplied to the fuel rail 3 by the low-pressure pump 6. Thus, fuel supply quantity and fuel injection quantity are equilibrated.

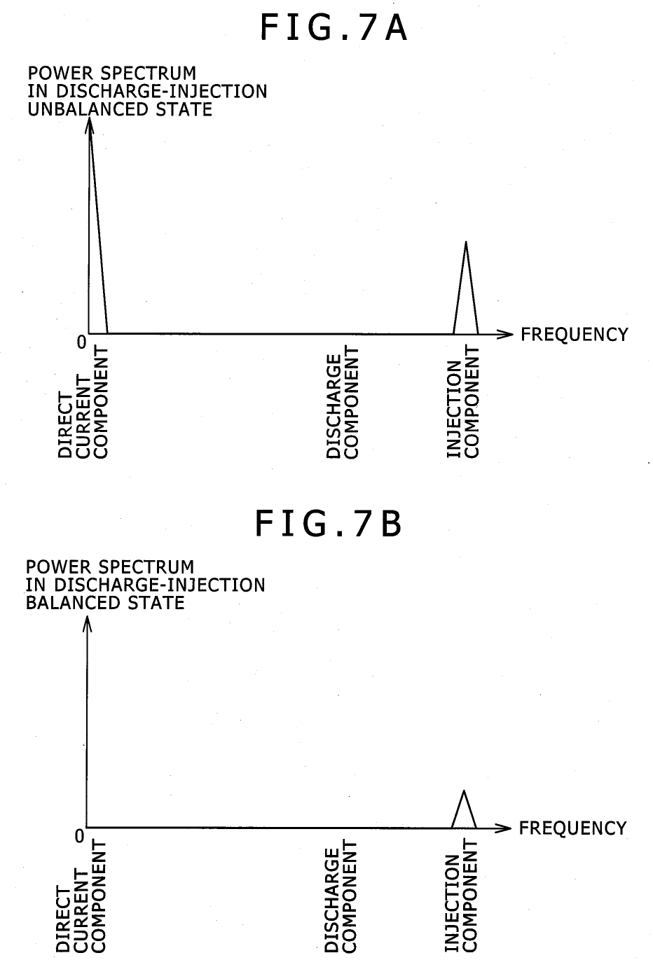

FIGS. 7A and 7B are a graph showing a power spectrum in a discharge-injection unbalanced state, and a graph showing a power spectrum in a discharge-injection balanced state, respectively.

As shown in FIG. 7A, in a period where the fuel pressure is decreasing monotonously and fuel supply quantity and fuel injection quantity are not equilibrated, the direct current component around 0 Hz that does not appear when the high-pressure fuel supply system is operating normally is the largest. As shown in FIG. 7B, no direct current component appears in a period where fuel supply quantity and fuel injection quantity are equilibrated. The pump discharge component is zero and the injection component is not zero in both the period where fuel supply quantity and fuel injection quantity are equilibrated and the period where fuel supply quantity and fuel injection quantity are not equilibrated because the high-pressure fuel pump 2 does not discharge the fuel and injection is performed in both the periods.

Thus, each of the components of fuel pressure has two patterns respectively for a discharge-injection balanced state where fuel supply quantity and fuel injection quantity are equilibrated and a discharge-injection unbalanced state where fuel supply quantity and fuel injection quantity are not equilibrated when the high-pressure fuel pump 2 is not discharging the fuel. The direct current component is the largest, the injection component is the second largest, and the rest of the components are substantially zero in a discharge-injection balanced state. The injection component is the largest and the rest of the components are substantially zero in a discharge-injection unbalanced state.

The fuel pressure variation pattern determining unit 13 one of the two calculated patterns, the trouble type determining unit 14 decides that the high-pressure fuel pump 2 is not discharging any fuel.

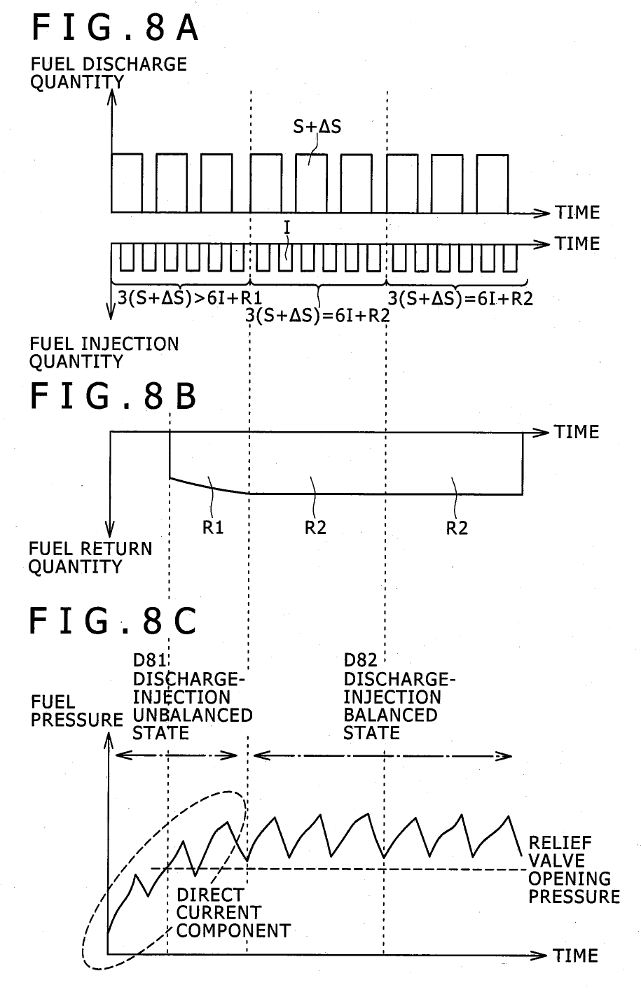

FIG. 8A is a graph showing the relation between fuel discharge quantity and fuel injection quantity when high-pressure fuel pump 2 is in an abnormal total discharge state where the high-pressure fuel pump 2 discharges all the fuel sucked from the fuel tank into the fuel rail 3.

As shown in FIG. 8A, fuel discharge quantity that is discharged by the high-pressure fuel pump 2 in one discharge cycle increases to S+ΔS and fuel injection quantity I remains unchanged in an abnormal total discharge state. Consequently, the fuel is supplied excessively to the fuel rail 3 and the fuel pressure in the fuel rail 3 increases continuously. When the high-pressure fuel pump 2 is in an abnormal total discharge state, the fuel is supplied excessively to the fuel rail 3 and the fuel pressure in the fuel rail 3 increases until the fuel pressure reaches a relief valve opening pressure. The relief valve 28 of the high-pressure fuel supply system opens upon the increase of the fuel pressure in the fuel rail 3 to the relief valve opening pressure to prevent the fuel pressure in the fuel rail 3 from increasing to a dangerous pressure. When the relief valve 28 opens, the fuel flows from the fuel rail 3 through the relief valve 28 into the fuel line 27.

As shown in FIGS. 8B and 8C, the fuel pressure in the fuel rail 3 continues increasing until the sum of fuel injection quantity that is injected by the injectors 4 and relieving fuel discharge quantity that is discharged through the relief valve 28, and fuel discharge quantity that is discharged by the high-pressure fuel pump 2 in one discharge cycle are equilibrated. The high-pressure fuel supply system is in a discharge-injection unbalanced state during a period between the time the abnormal total discharge state starts and the time the fuel pressure reaches the relief valve opening pressure, and a period D81 in which a fuel discharge quantity 3 (S+ΔS) is greater than the sum of an fuel injection quantity 6I and a relieving fuel discharge quantity R1. The high-pressure fuel supply system is in a discharge-injection balanced state in a period D82 in which a fuel discharge quantity 3 (S+αS) is equal to the sum of an fuel injection quantity 6I and a relieving fuel discharge quantity R1 after the fuel pressure in the fuel rail 3 has reached the relief valve opening pressure.

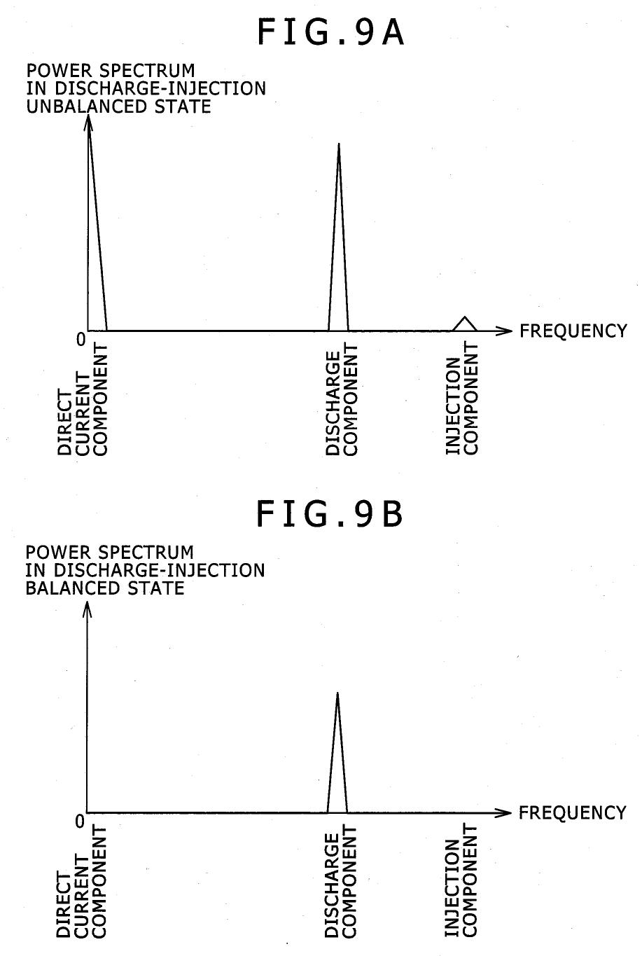

FIGS. 9A and 9B are a graph showing a power spectrum in a discharge-injection unbalanced state and a graph showing a power spectrum in a discharge-injection balanced state. As shown in FIG. 9A, the direct current component around 0 Hz that does not appear when the high-pressure fuel supply system is operating normally is the largest and the pump discharge component is the second largest in a discharge-injection unbalanced state. The injection component is very small because a large amount of fuel is discharged through the relief valve 28. As shown in FIG. 9B, no direct current component appears and only the pump discharge component appears in a discharge-injection balanced state, the injection component is small for the same reason and is substantially zero in a discharge-injection balanced state. Thus, each of the components of the fuel pressure has two patterns when the high-pressure fuel pump 2 is in an abnormal total discharge state. The direct current component is the largest, the pump discharge component is the second largest and the rest of the components are substantially zero in one of the patterns. Only the pump discharge component appears and the rest of the components are substantially zero in the other pattern.

When one of the two calculated patterns is obtained by the calculated pattern determining unit 13, the trouble type determining unit 14 decides that high-pressure fuel pump 2 is in an abnormal total discharge state.

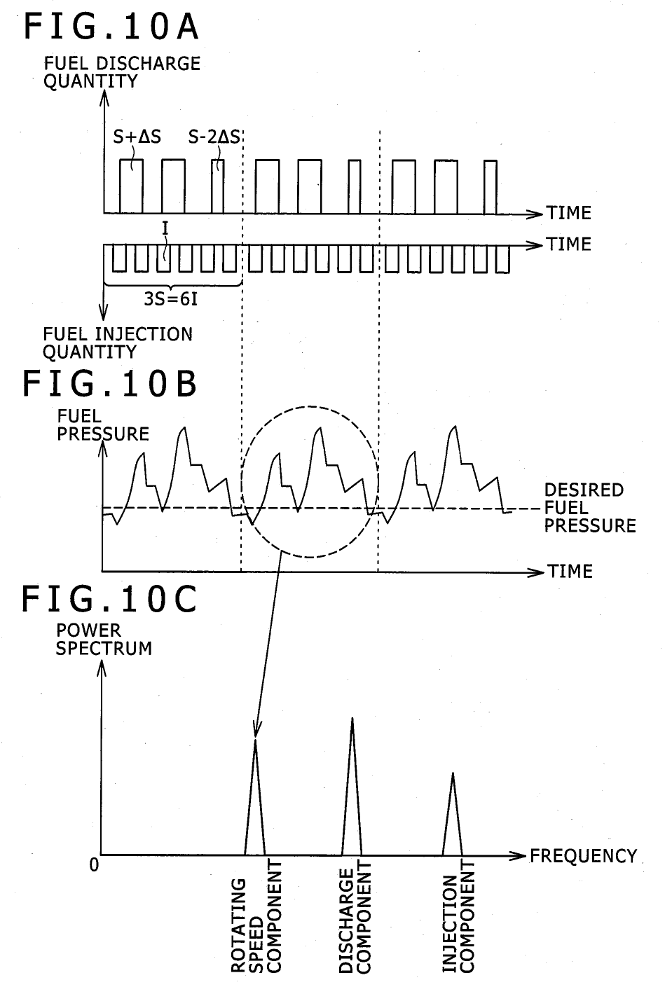

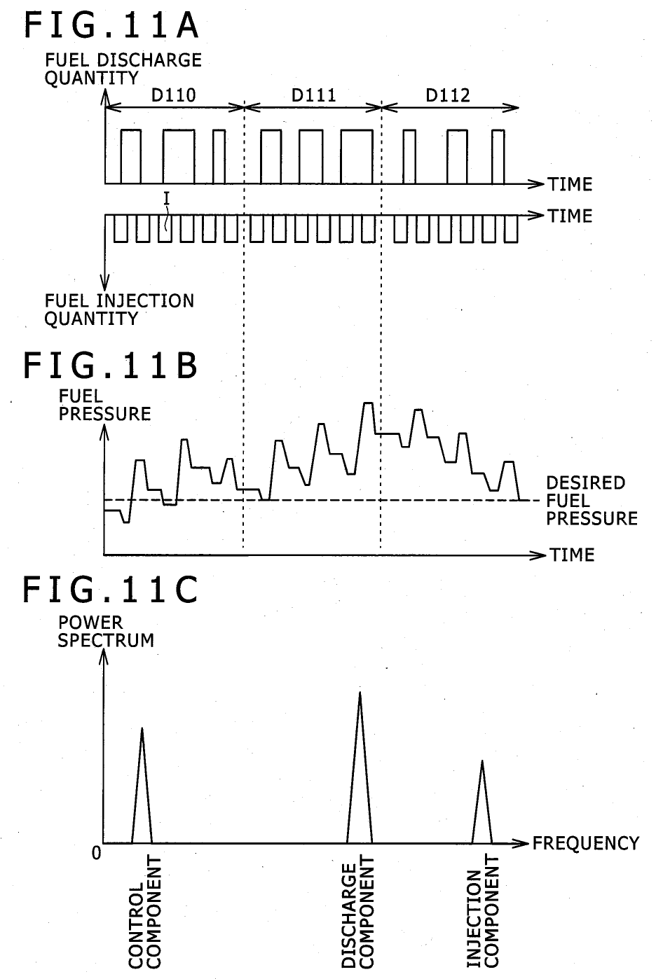

An abnormal condition in which an error in controlling fuel discharge quantity that is discharged by the high-pressure fuel pump 2 in one discharge cycle is large and the actual fuel discharge quantity does not coincide with a desired fuel discharge quantity will be described with reference to FIGS. 10 and 11.

FIGS. 10A, 10B and 10C are a graph showing the relation between fuel discharge quantity and fuel injection quantity when the pump driving cam 21 for driving the high-pressure fuel pump 2 is malfunctioning, a graph showing the waveform of fuel pressure when the pump driving cam 21 is malfunctioning, and a power spectrum obtained from the waveform of fuel pressure shown in FIG. 10B, respectively.

An error is made in fuel discharge quantity when the pump driving cam 21 rotates. Suppose that a fuel discharge quantity 3S that is discharged while the pump driving cam 21 makes one full turn is equal to an fuel injection quantity 6I that is injected while the pump driving cam 21 makes one full turn, the fuel of a fuel discharge quantity of S+αS is discharged in the first and the second discharge cycle, and the fuel of a fuel discharge quantity of S−2ΔS is discharged in the third discharge cycle as shown in FIG. 10A, in which S designates a desired fuel discharge quantity.

Although the fuel pressure is controlled so as to be approximately equal to a desired fuel pressure, the fuel pressure varies according to an error in fuel discharge quantity. The fuel pressure increases when fuel discharge quantity is large and decreases when fuel discharge quantity is small as shown in FIG. 10B.

As shown in FIG. 10C, in the power spectrum, the pump discharge component is the largest, the rotating speed component is the second largest, the injection component is the third largest and the rest of the components are substantially zero.

Whereas the rotating speed component is substantially zero in a power spectrum in a normal state, the rotating speed component appears in a spectrum when the pump driving cam 21 is in an abnormal operation. The rotating speed component appears because fuel discharge quantity that is discharged by the high-pressure fuel pump 2 varies periodically according to the rotation of the pump driving cam 21 and the fuel pressure varies in synchronism with the periodic variation of fuel discharge quantity. The rotating speed component is smaller than the pump discharge component because the appearance of the rotating speed component is caused by fuel discharge quantity error ΔS and it is inferred that the rotating speed component is small because fuel discharge quantity error ΔS is small as compared with desired fuel discharge quantity S.

When a calculated pattern in which the pump discharge component is the largest, the rotating speed component is the second largest and the injection component is the third largest is obtained by the calculated pattern determining unit 13, the trouble type determining unit 14 decodes that a trouble occurred in the pump driving cam 21 for driving the high-pressure fuel pump 2.

FIGS. 11A, 11B and 11C are graphs showing the relation between fuel discharge quantity and fuel injection quantity, the waveform of fuel pressure, and a power spectrum obtained from the waveform of fuel pressure shown in FIG. 11B, respectively, when suction valve opening duration for which the suction valve 25 of the high-pressure fuel pump 2 is opened is irregular.

The operation of the suction valve 25 is dependent on the pressure difference between the pressure chamber 22 of the high-pressure fuel pump 2 and the low-pressure pump 6, and the condition of the solenoid 24 for operating the suction valve 25. Therefore, suction valve opening duration varies according to the pulsation of the pressure difference and the pulsation of voltage applied to the solenoid 24. The variation of suction valve opening duration is not periodic like the periodic variation of fuel discharge quantity resulting from a trouble in the pump driving cam 21 and is irregular.

As shown in FIG. 11A, fuel suction quantity that is sucked by the high-pressure fuel pump 2 in one suction cycle varies if suction valve opening duration for which the suction valve 25 is opened varies and, consequently, fuel discharge quantity changes. It is supposed herein that suction valve opening duration is longer than a desired suction valve opening duration and fuel discharge quantity is larger than a desired fuel discharge quantity in periods D110 and D111 by way of example.

As shown in FIG. 11B, the fuel pressure increases gradually with the increase of fuel discharge quantity in periods D110 and D111. When the ECU controls the solenoid 24 to shorten the duration of opening of the suction valve 25, fuel discharge quantity is reduced to reduce the fuel pressure to a value near the desired fuel pressure in a period D112.

As shown in FIG. 11C, the pump discharge component is the largest, the control component indicating fuel pressure variation resulting from the control operation is the second largest, the injection component is the third largest and the rest of the components are substantially zero in the power spectrum. The control component appears in the power spectrum because a control operation different from a normal control operation is executed to make fuel pressure caused to vary by irregular suction valve opening duration at a desired fuel pressure. It is conjectured that the control component is smaller than the pump discharge component because the control component arises from an error in fuel discharge quantity made by an error in the suction valve opening duration and the error in fuel discharge quantity is small as compared with the normal fuel discharge quantity S.

When a calculated pattern in which the pump discharge component is the largest, the control component is the second largest and the injection component is the third largest is determined by the calculated pattern determining unit 13, the trouble type determining unit 14 decides that the duration of opening the suction valve 25 of the high-pressure fuel pump 2 is irregular.

In FIGS. 11A and 11B, the fuel pressure increases due to the irregular suction valve opening duration and the solenoid 24 is controlled so as to make the fuel pressure converge at the desired fuel pressure. On the contrary, the pump discharge component is the largest, the control component is the second largest and the injection component is the third largest in a power spectrum as shown in FIG. 11C when the fuel pressure decreases due to the variation of the opening duration of the suction valve 25 and the fuel pressure is increased by controlling the solenoid 24 so as to converge at the desired fuel pressure.

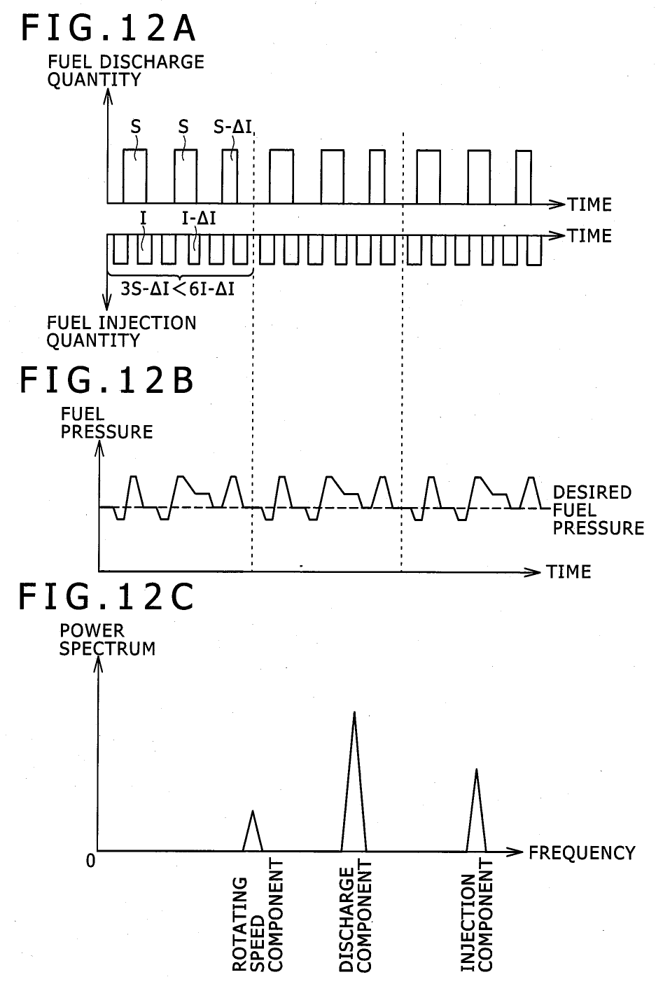

FIGS. 12A, 12B and 12C are a graph showing relation between fuel discharge quantity and fuel injection quantity when an injector is clogged, a graph showing the waveform of fuel pressure when an injector is clogged, and a graph showing a power spectrum obtained from the waveform of fuel pressure shown in FIG. 12B, respectively.

For example, when the fourth injector 4 is clogged, as shown in FIG. 12A, the fourth injector 4 injects the fuel by a reduced fuel injection quantity of I−ΔI and, consequently, the fuel pressure in the fuel rail 3 increases. Then, fuel discharge quantity is reduced by ΔI so that a discharge-injection balanced state in which 3S−ΔI=6I−ΔI is created to make the fuel pressure converge at a value near the desired fuel pressure.

As shown in FIG. 12B, a condition in which the fuel pressure rises when the clogged fourth injector 4 injects the fuel and the fuel pressure drops, when fuel supply quantity of the fuel supplied into the fuel rail 3, namely, fuel discharge quantity, is reduced, occurs periodically to control the fuel pressure in the fuel rail 3 so as to vary around the desired fuel pressure.

As shown in FIG. 12C, the pump discharge component is the largest, the injection component is the second largest, the rotating speed component is the third largest and the rest of the components are substantially zero in a spectrum as shown in FIG. 12C.

Such a power spectrum appears when one of the injectors 4 malfunctions because the injection period of each injector coincides with the rotating period of the pump driving cam 21 and hence, when one of the injectors 4 malfunctions, the variation of the fuel pressure resulting from the malfunction of the injector 4 is synchronous with the rotation of the pump driving cam 21. It is conjectured that the rotating speed component is smaller than the injection component because the rotating speed component is caused to appear by the an decrement ΔI in fuel injection quantity and the reduction ΔI in fuel injection quantity is small as compared with the total fuel injection quantity 6I of all the injectors 4.

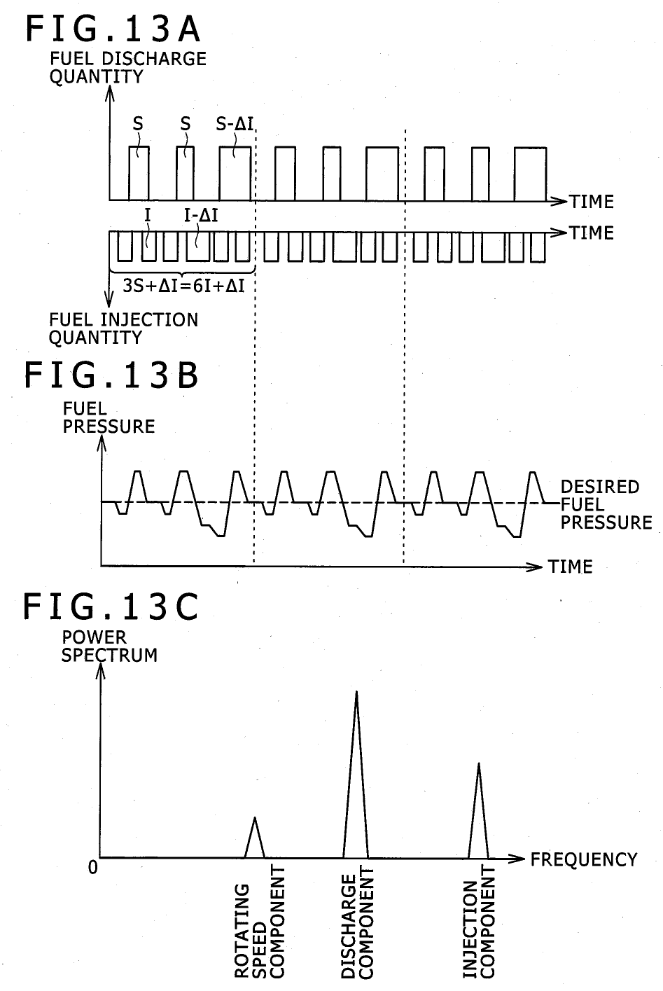

FIG. 13A is a graph showing the relation between fuel discharge quantity and fuel injection quantity when fuel injection quantity that is injected by the fourth injector 4 is increased by an increment ΔI. Such an increase in fuel injection quantity occurs when the response characteristic of the solenoid, not shown, of the injector 4, is deteriorated by aging and the solenoid cannot properly control the fuel injecting operation of the injector 4 so as to inject the fuel of the correct fuel injection quantity.

When fuel injection quantity that is injected by the fourth injector 4 increases by an increment ΔI as shown in FIG. 13A, the fuel pressure in the fuel rail 3 drops. Then, fuel discharge quantity that is discharged by the high-pressure fuel pump 2 is increased by ΔI to create a discharge-injection balanced state, in which 3S+ΔI=6I+ΔI.

As shown in FIG. 13B, the fuel pressure is caused to vary periodically around the desired fuel pressure by increasing fuel discharge quantity and fuel injection quantity.

as shown in FIG. 13C, the pump discharge component is the largest, the injection component is the second largest, the rotating speed is the third largest and the rest of the components are substantially zero in a power spectrum. The power spectrum shown in FIG. 13C is identical with that shown in FIG. 12C, because the injection period of each injector 4 is synchronous with the rotation of the pump driving cam 21 and the increment ΔI in fuel injection quantity is small as compared with the total fuel injection quantity 6I that is injected by all the injectors 4 in the abnormal condition where fuel injection quantity injected by one of the injectors 4 increases due to the malfunction of the solenoid of the injector 4 similarly to those in the abnormal condition where fuel injection quantity injected by one of the injectors 4 decreases due to the clogging of the injector 4 as mentioned in connection with FIG. 12.

Although the change in fuel injection quantity when the fourth injector 4 is clogged shown in FIG. 12A and the change in fuel injection quantity when the solenoid of the fourth injector 4 malfunctions shown in FIG. 13A are opposite to each other, the patterns of the components shown in FIG. 13C are identical with those shown in FIG. 12C. Therefore, it is impossible to know how fuel injection quantity changed from only the calculated pattern.

To discriminate between the change in fuel injection quantity due to the clogging of the injector 4 and the change in fuel injection quantity due to the malfunction of the solenoid, absolute values of the components of an obtained spectrum are compared with absolute values of the components of a spectrum in the normal state. The fuel pressure component comparing unit 12 compares the components determined by the fuel pressure component calculating unit 11 with the known components in the normal state.

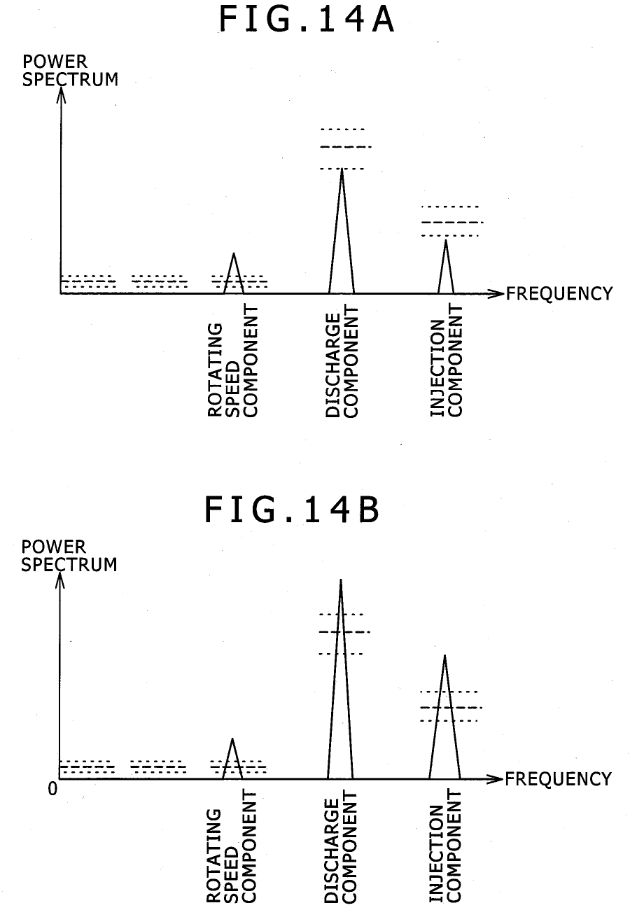

Decrease in fuel injection quantity due to the clogging of the injector 4 causes fuel discharge quantity to decrease. Therefore, the injection component and the pump discharge component in a state where the injector 4 is clogged are smaller than those in the normal state as shown in FIG. 14A.

The injection component and the pump discharge component in a state where fuel injection quantity increases due to the malfunction of the solenoid causes are greater than those in the normal state as shown in FIG. 14B. When such a pattern indicating the malfunction of the signal injector is obtained, the cause of malfunction can be identified by comparing absolute values of the components of the pattern with those of the components of the pattern in the normal state. Thus, the identification of troubles can be easily applied to control operations for dealing with troubles.

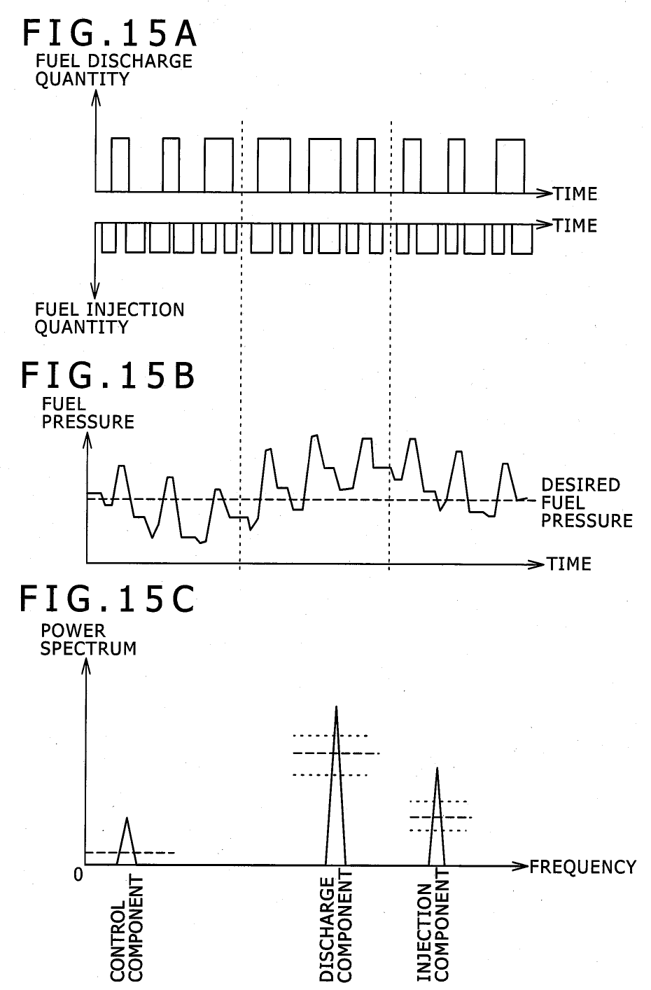

FIGS. 15A, 15B and 15C are graphs showing the relation between fuel discharge quantity and fuel injection quantity, the waveform of fuel pressure and a power spectrum, respectively, when the respective injection quantities of some of the injectors 4 are irregular.

The injectors 4 have mechanical errors made during the manufacture of the same and inject the fuel at different injection quantities, respectively, due to aging. The respective injection quantities of the injectors 4 vary irregularly.

The total fuel injection quantity injected by all the injectors 4 into the cylinders, respectively, increases due to the irregularly varying fuel injection quantities of the injectors 4 as shown in FIG. 15A. When the fuel pressure continues to decrease as the fuel injection quantity increases, the ECU executes a fuel pressure control operation to increase fuel discharge quantity to increase the fuel pressure near to the desired fuel pressure as shown in FIG. 15B.

The pump discharge component is the largest, the injection component is the second largest, the control component is the third largest and the rest of the components are substantially zero as shown in FIG. 15C.

It is conjectured that the control component is smaller than the injection component because the error in the fuel injection quantity caused by irregular injection is small as compared with fuel injection quantity in the normal state. It is hardly possible that the error in fuel injection quantity exceeds fuel injection quantity in the normal state.

When the calculated pattern determining unit 13 obtains a calculated pattern in which the pump discharge component is the largest, the injection component is the second largest and the control component is the third largest, the trouble type determining unit 14 decides that the fuel injection quantity that is injected by the injectors 4 is irregular.

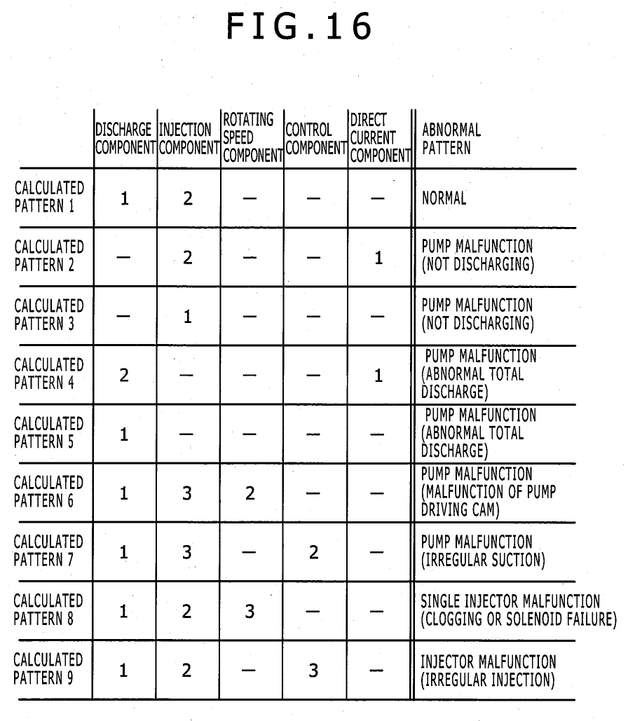

FIG. 16 is a table showing the relation between the calculated patterns described in connection with FIGS. 4 to 15 and trouble types. As mentioned above, the calculated pattern determining unit 13 stores results of comparison made by the fuel pressure component comparing unit 12, namely, order in magnitude of the components and the absolute values of the components, and forms a calculated pattern on the basis of the results of comparison. A table of a plurality of abnormal and normal patterns and trouble types corresponding to those patterns is stored beforehand in the trouble type determining unit 14. An abnormal pattern in agreement with a calculated pattern determined by the calculated pattern determining unit 13 is chosen from the table and a trouble type is determined from the abnormal (normal) pattern.

The diagnostic apparatus 1 in this embodiment compares the respective magnitudes of the discharge and injection components calculated on the basis of the measured fuel pressure and determines the type of a trouble in the high-pressure fuel supply system with reference to the calculated pattern based on the results of comparison. The diagnostic apparatus 1 can simultaneously achieve the detection of a trouble in the high-pressure fuel supply system and the determination of a part in which the trouble occurred by taking into consideration the results of comparison of the plurality of components for diagnosis. When the fuel discharge quantity discharged by the high-pressure fuel pump is caused to vary by the malfunction of the injectors, the conventional diagnostic apparatus sometimes makes wrong diagnosis and determines that the high-pressure fuel pump is malfunctioning. The diagnostic apparatus 1 of the present invention can discriminate between an abnormal operation of the high-pressure fuel pump 2 and an abnormal operation of the injector 4.

The diagnostic apparatus 1 in this embodiment determines the type of a trouble on the basis of the components and the magnitudes of the components determined by the fuel pressure component calculating unit 11. Therefore, it is necessary to make diagnosis on the premise that fuel discharge quantity and fuel injection quantity are equilibrated in the normal state. The diagnostic apparatus 1 continuously monitors the operation of the internal combustion engine to see whether or not the internal combustion engine is operating in a discharge-injection balanced state and prohibits or interrupts diagnosing the high-pressure fuel supply system when the internal combustion engine goes into an operation in a discharge-injection unbalanced state. A diagnostic operation for diagnosing the high-pressure fuel supply system is prohibited or interrupted at the start of the internal combustion engine or when the fuel is cut, for example, to decelerate the vehicle.

FIG. 16 is a flow chart of a diagnosis prohibiting procedure. Referring to FIG. 16, a query is made in step S171 to see whether or not the internal combustion engine is in a starting mode. If the response to the query made in step S171 is negative, a query is made in step S172 to see whether or not the internal combustion engine is in a fuel cut state. Diagnosis of the high-pressure fuel supply system is prohibited or interrupted immediately when diagnosis is in progress in step S173 if the response to the query made in step S171 or S172 is affirmative. If the internal combustion engine is not in the starting mode and the response to the query made in step S171 is negative or if the fuel is not cut and the response to the query made in step S172 is negative, the high-pressure fuel supply system is diagnosed.

The diagnostic apparatus 1 monitors the discharge-injection balance continuously and inhibits the diagnosis of the high-pressure fuel supply system or interrupts the diagnosis of the high-pressure fuel supply system if diagnosis is in progress upon the detection of a discharge-injection unbalanced state to avoid making wrong diagnosis of the high-pressure fuel supply system.

A diagnostic apparatus in a second embodiment according to the present invention will be described.

The diagnostic apparatus in the second embodiment is the same in basic construction as the diagnostic apparatus in the first embodiment. Where as the fuel pressure component calculating unit 11 of the first embodiment obtains the power spectrum through the frequency analysis, such as Fourier transform, of the fuel pressure waveform, the second embodiment obtains the components, such as a pump discharge component, an injection component, a rotating speed component and a control component by filtering the fuel pressure waveform provided by a fuel pressure measuring unit.

A method of calculating the components by a fuel pressure component calculating unit 11 will be described.

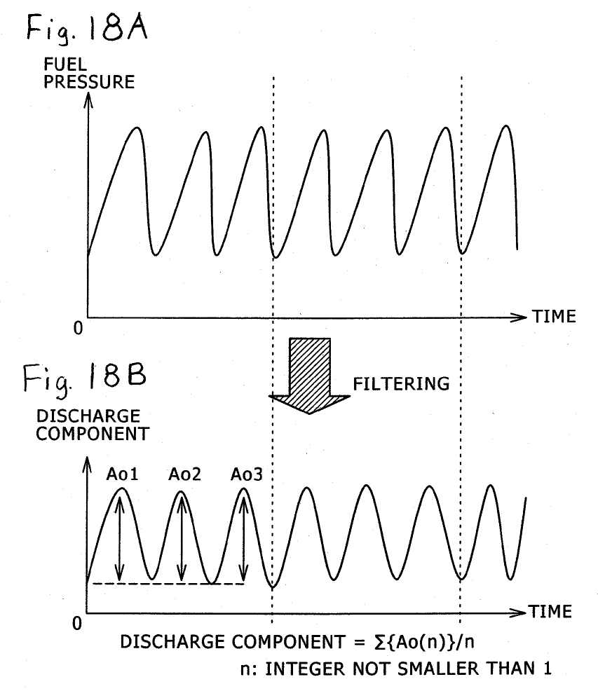

FIG. 18A is a graph showing a fuel pressure waveform of the fuel pressure in a fuel rail 3 and FIG. 18B is a graph showing the waveform of a pump discharge component obtained by filtering the fuel pressure waveform shown in FIG. 18A.

Referring to FIGS. 18A and 18B, a fuel pressure variation in the vicinity of the discharge period of a high-pressure fuel pump 2 is extracted by filtering the fuel pressure waveform given to a fuel pressure component calculating unit 11 by a fuel pressure measuring unit 51. The mean of peak values of the extracted fuel pressure variation is treated as a pump discharge component.

A filtering method uses a generally known digital filter, such as an infinite impulse response filter (IIR filter), a finite impulse response filter (FIR filter), a Kárman filter, a Butterworth filter or a Shebichefu filter. Even if the internal combustion is in a steady state, the actual discharge period of the high pump is not fixed because the operating speed of the internal combustion engine is variable even if the internal combustion engine is in a steady state. The variation of the operating speed is dependent on operating condition. Suppose that the rotating speed of the high-pressure fuel pump varies in the range of ±75 rpm. Then, the fuel discharge frequency of the high-pressure fuel pump varies in the range of ±2 Hz. A waveform of pump discharge component as shown in FIG. 18B is obtained by filtering the fuel pressure waveform by a filter capable of extracting frequencies in the frequency range of discharge frequency ±2 Hz. The mean of the amplitudes Ao1, Ao2, Ao3 . . . and Aon of peaks in the waveform of pump discharge component is calculated and is given as a pump discharge component to a fuel pressure component comparing unit 12.

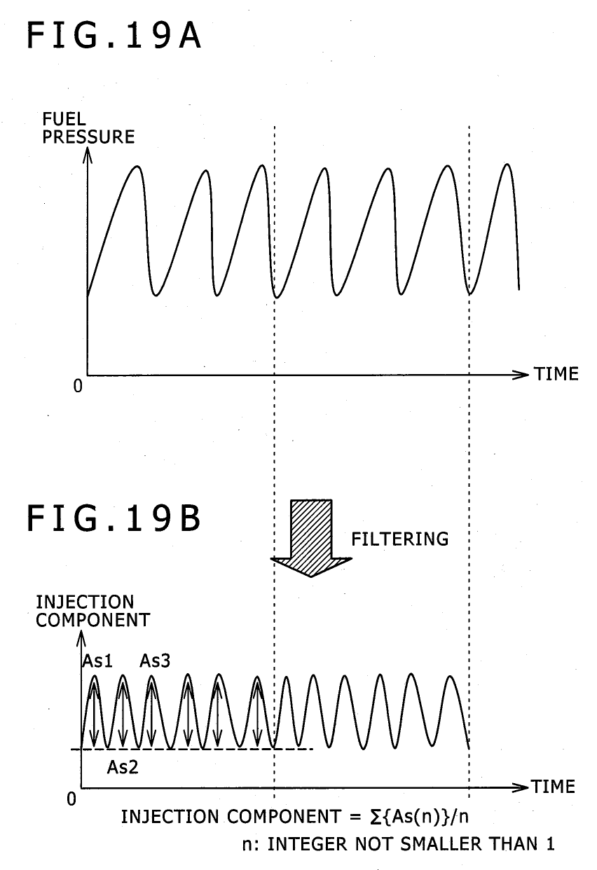

FIGS. 19A and 19B are a graph showing a fuel pressure waveform of the fuel pressure in a fuel rail 3, and the waveform of an injection component extracted from the waveform of the fuel pressure shown in FIG. 19A by filtering, respectively.

Referring to FIGS. 19A and 19B, fuel pressure variation around the injection period of the high-pressure fuel pump 2 is extracted by filtering the fuel pressure waveform by a method similar to the foregoing method of calculating the pump discharge component. The mean of peak values in the extracted variation is used as an injection component. Injection period, similarly to discharge period, varies according to the variation of the operating speed of the internal combustion engine. The range of variation of injection frequency caused by the variation of the operating speed is about ±4 Hz. The waveform of the injection component shown in FIG. 19B is obtained by filtering the fuel pressure waveform by a filter capable of extracting frequencies in the range of injection frequency ±4 Hz. The mean of the amplitudes As1, As2, As3, . . . and Asn of peaks in the waveform of injection component is calculated and is given as an injection component to the fuel pressure component comparing unit 12.

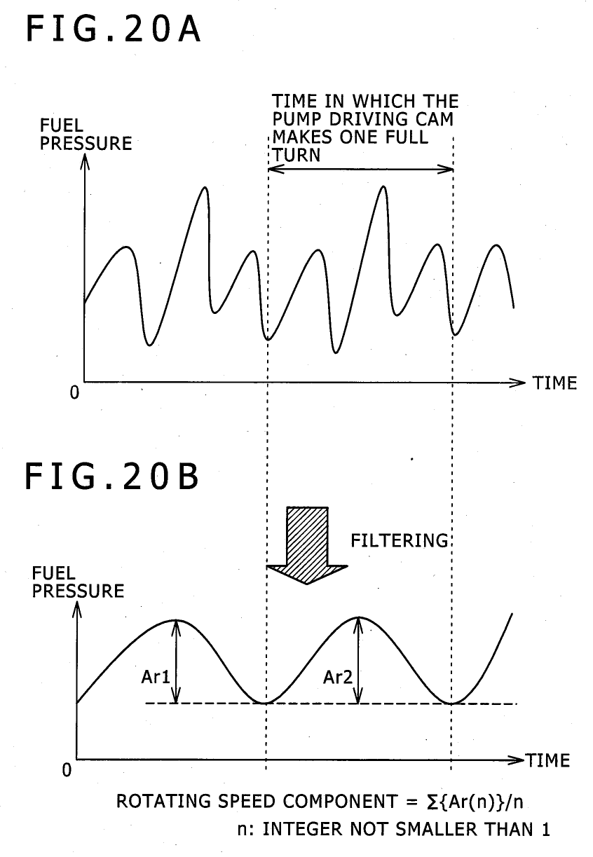

Referring to FIGS. 20A and 20B, fuel pressure variation around the frequency of rotation of a pump driving cam 21 driving the high-pressure fuel pump 2 is extracted by filtering the fuel pressure waveform by a method similar to the foregoing method of calculating the pump discharge component. The mean of peak values in the extracted variation is used as a rotating speed component.

The range of variation of the rotating speed of the pump driving cam 21 resulting from the variation of the operating speed of the internal combustion engine is about ±1 Hz. A waveform of rotating speed component as shown in FIG. 20B is obtained by filtering the fuel pressure waveform by a filter capable of extracting frequencies in the frequency range of pump driving cam rotation frequency ±1 Hz. The mean of the amplitudes Ar1, Ar2, Ar3 . . . and Arn of peaks in the waveform of rotating speed component is calculated and is given as a rotating speed component to the fuel pressure component comparing unit 12.

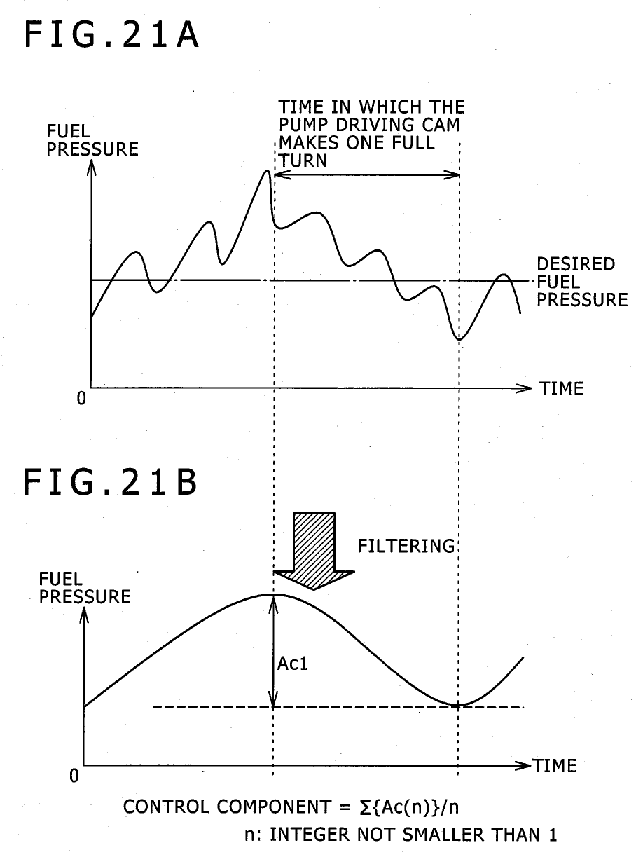

Referring to FIGS. 21A and 21B, fuel pressure variation in the range of 0 Hz to a frequency below the rotation frequency of the pump driving cam 21 for driving the high-pressure fuel pump 2 is extracted by filtering the fuel pressure waveform by a method similar to the foregoing method of calculating the pump discharge component. The mean of peak values in the extracted variation is used as a control component.

A waveform of control component as shown in FIG. 21B is obtained by filtering the fuel pressure waveform by a filter capable of extracting frequencies in the frequency range of 0 Hz to a frequency below the rotation frequency of the pump driving cam 21 for driving the high-pressure fuel pump 2. The mean of the amplitudes Ac1, Ac2, Ac3 . . . and Acn of peaks in the waveform of the control component is calculated and is given as a control component to the fuel pressure component comparing unit 12.

Although the invention has been described in its preferred embodiments with a certain degree of particularity, obviously many changes and variations are possible therein. It is therefore to be understood that the present invention may be practiced otherwise than as specifically described herein without departing from the scope and spirit thereof.

What is claimed is:

1. A diagnostic apparatus, for a high-pressure fuel supply system including a high-pressure fuel pump capable of discharging high-pressure fuel, a fuel rail capable of accumulating the high-pressure fuel discharged by the high-pressure fuel pump, injectors connected to the fuel rail to inject the fuel into an internal combustion engine, and a fuel pressure measuring unit for measuring fuel pressure in the fuel rail; capable of controlling and diagnosing the high-pressure fuel pump on the basis of a fuel pressure measured by the fuel pressure measuring unit, said diagnostic apparatus comprising:
a pump discharge component calculating unit for determining fuel pressure variation synchronous with the operation of the high-pressure fuel pump from the fuel pressure;
an injection component calculating unit for determining fuel pressure variation synchronous with the operation of the injectors;
a rotating speed component calculating unit for determining fuel pressure variation synchronous with the rotation of a drive shaft for driving the high-pressure fuel pump;
a control component calculating unit for determining fuel variation during a control operation for adjusting the fuel pressure to a predetermined desired fuel pressure; and
a direct current component calculating unit for calculating a direct current component of fuel pressure variation;
wherein a decision is made on whether or not the high-pressure fuel system is malfunctioning on the basis of results of calculation made by the pump discharge component calculating unit, the injection component calculating unit, the rotating speed component calculating unit, the control component calculating unit, and the direct current component calculating unit.

2. The diagnostic apparatus according to claim 1 further comprising: a fuel pressure component comparing unit for comparing the pump discharge component, the injection component, the rotating speed component, the control component and the direct current component to determine order in magnitude of those components, and a trouble type determining unit for determining a type of a trouble in the high-pressure fuel system on the basis of the result of comparison made by the fuel pressure component comparing unit.

3. The diagnostic apparatus according to claim 2, wherein the trouble type determining unit stores beforehand normal patterns showing the relation in magnitude among the components when the high-pressure fuel system is in a normal operation, decides that the high-pressure fuel system is in a normal condition when a pattern based on the result of comparison made by the fuel pressure component comparing unit coincides with the normal patterns or the high-pressure fuel system is in an abnormal condition when the pattern does not coincide with the normal pattern.

4. The diagnostic apparatus according to claim 2, wherein the trouble type determining unit stores beforehand at least one of magnitude patterns of the components when the high-pressure fuel system is in an abnormal condition, and the type of a trouble in the high-pressure fuel system is determined when the measured pattern based on the result of comparison made by the fuel pressure component comparing unit coincides with the trouble pattern.

5. The diagnostic apparatus according to claim 3, wherein it is decided that the high-pressure fuel system is in a normal condition when the pump discharge component is the largest, the injection component is the second largest, and the rotating speed component, the control component and the direct current component are smaller than a lower limit of a predetermined range.

6. The diagnostic apparatus according to claim 4, wherein it is decided that the high-pressure fuel pump is malfunctioning and is not discharging the fuel when the direct current component is the largest and the injection component is the second largest.

7. The diagnostic apparatus according to claim 4, wherein it is decided that the high-pressure fuel pump is malfunctioning and not discharging the fuel when the injection component is the largest.

8. The diagnostic apparatus according to claim 4, wherein it is decided that the high-pressure fuel pump is in an abnormal total fuel discharge state when the direct current component is the largest and the pump discharge component is the second largest.

9. The diagnostic apparatus according to claim 4, wherein it is decided that the high-pressure fuel pump is in an abnormal total fuel discharge state when the pump discharge component is the largest.

10. The diagnostic apparatus according to claim 4, wherein it is decided that a pump driving cam for driving the high-pressure fuel pump has a trouble when the pump discharge component is the largest, the rotating speed component is the second largest and the injection component is the third largest.

11. The diagnostic apparatus according to claim 4, wherein it is decided that time for which a fuel suction valve connected to a suction port of the high-pressure fuel pump is open is irregular when the pump discharge component is the largest, the control component is the second largest and the injection component is the third largest

12. The diagnostic apparatus according to claim 4, wherein it is decided that the injector is clogged or a solenoid driving the injector is abnormal when the pump discharge component is the largest, the injection component is the second largest and the rotating speed component is the third largest.

13. The diagnostic apparatus according to claim 4, wherein it is decided that an injection quantity that is injected by the injector in one injection cycle is irregular when the pump discharge component is the largest, the injection component is the second largest and the control component is the third largest.

14. The diagnostic apparatus according to claim 1, wherein a process for prohibiting or interrupting a diagnostic operation for diagnosing the high-pressure fuel supply system is executed when a fuel discharge quantity that is discharged by the high-pressure fuel pump in a predetermined period and a fuel injection quantity that is injected by the injectors in the same predetermined time do not coincide with each other.

15. The diagnostic apparatus according to claim 1, wherein a process for prohibiting or interrupting a diagnostic operation for diagnosing the high-pressure fuel supply system is executed at the start of the internal combustion engine or when the fuel is cut.
